(19) United States
(12) Patent Application Publication
(10) Pub. No.: US 2007/0289013 A1
(43) Pub. Date: Dec. 13, 2007

(54) Method and system for anomaly detection using a collective set of unsupervised machine-learning algorithms

(76) Inventor: Keng Leng Albert Lim, (US)

Correspondence Address: GOODWIN PROCTER L.L.P, 599 LEXINGTON AVE., NEW YORK, NY, 10022, US

(21) Appl. No.: 11/449,533

(22) Filed: Jun. 8, 2006

(51) Int. Cl. G06F 12/14

(52) U.S. Cl. 726/22

(57) ABSTRACT

An anomaly detection system comprising, one or more distributed sensors for gathering network or log data; one or more generators for generating discovery rules based on a collective set of pattern discovery algorithms including one or more unsupervised machine learning algorithms; one or more detectors for detecting abnormal patterns in the network or log data gathered by the sensors based on the discovery rules generated by the generator; and one or more correlation engine for determining intrusion counter measures based on matching features of one or more detected abnormal patterns with correlation rules.

### FIELD OF INVENTION

The present invention relates broadly to an anomaly detection system and to an anomaly detection method, using a collective set of unsupervised machine-learning algorithms.

### BACKGROUND

Intrusion detection was developed to provide network security and to monitor network activity. There are two major types of intrusion detection systems (IDS). Typical intrusion detection systems are placed at determined points on the network to compare traffic packets against a set of known rules or patterns or “signatures” that represent suspicious activity, misuse, or actual attacks. An anomaly intrusion detection system typically estimates nominal system behaviour and rise alarms when there is behavioural departure from nominal system profiles. This anomaly of behavioral departure may represent potential intruding activity on the system.

U.S. Pat. No. 6,681,331 discloses “a real-time approach for detecting aberrant modes of system behaviour induced by abnormal and unauthorized system activities that are indicative of an intrusive, undesired access of the system. This detection methodology is based on behavioural information obtained from a suitably instrumented computer program as it is executing.” This method of intrusion detection is based on a set of pre-defined computing functionalities as sequential events and on a varying criterion level of potential new intrusion events of computer programs.

U.S. Pat. No. 6,769,066 discloses “detecting harmful or illegal intrusions into a computer network or into restricted portions of a computer network uses a process of synthesizing anomalous data to be used in training a neural network-based model for use in a computer network intrusion detection system. Anomalous data for artificially creating a set of features reflecting anomalous behaviour for a particular activity is performed.” The method of intrusion detection is typically classified as a supervised training system as deemed abnormal data is typically required to provide a pre-defined profile of normal behaviour.

### SUMMARY

Existing IDS still do not utilize multiple self-training machine-learning algorithms to train themselves. These IDS also typically do not incorporate more than one neural-network-based or machine-learning-based algorithms to function in a collective manner to correlate and improve the accuracy of attack detection. More importantly, existing IDS still have inherent flaws of generating too many false alarms and being unable to respond to attacks.

In accordance with a first aspect of the present invention, there is provided an anomaly detection system comprising, one or more distributed sensors for gathering network or log data; one or more generators for generating discovery rules based on a collective set of pattern discovery algorithms including one or more unsupervised machine learning algorithms; one or more detectors for detecting abnormal patterns in the network or log data gathered by the sensors based on the discovery rules generated by the generator; and one or more correlation engine for determining intrusion counter measures based on matching features of one or more detected abnormal patterns with correlation rules.

In accordance with a second aspect of the present invention, there is provided an anomaly detection method comprising, utilising one or more distributed sensors for gathering network or log data; utilising one or more generators for generating discovery rules based on a collective set of pattern discovery algorithms including one or more unsupervised machine learning algorithms; utilising one or more detectors for detecting abnormal patterns in the network or log data gathered by the sensors based on the discovery rules generated by the generator; and utilising one or more correlation engine for determining intrusion counter measures based on matching features of one or more detected abnormal patterns with correlation rules.

### BRIEF DESCRIPTION OF THE DRAWINGS

Embodiments of the invention will be understood better and readily apparent to one skilled in the art from the following written description, by way of example only, and in conjunction with the drawings, in which:

FIG. 1 is a schematic diagram illustrating a Pattern Discovery Engine (PDE) in an example embodiment.

FIG. 2 is a schematic diagram illustrating a TIF Discovery Engine in an example embodiment.

FIG. 3 is a flowchart illustrating steps to configure sensors in a Pattern Discovery Engine in an example embodiment.

FIG. 4 is a flowchart illustrating steps to configure a Pattern Discovery Engine in an example embodiment.

FIG. 5 is a flowchart illustrating steps to configure a Pre-processor module in a Pattern Discovery Engine in an example embodiment.

FIG. 6 is a flowchart illustrating steps to configure a Generator in a Pattern Discovery Engine in an example embodiment.

FIG. 7 is a flowchart illustrating steps to utilize a Self Organising Feature Maps (SOM) algorithm in a Pattern Discovery Engine in an example embodiment.

FIG. 8 is a flowchart illustrating steps to utilize a Clustering for Anomaly Detection (CLAD) algorithm in a Pattern Discovery Engine in an example embodiment.

FIG. 9 is a flowchart illustrating steps to configure detectors in a Pattern Discovery Engine in an example embodiment.

FIG. 10 is a flowchart illustrating steps to configure a Master Correlation Engine in an example embodiment.

FIG. 11 is a flowchart illustrating steps to create a new correlation rule in a Master Correlation Engine in an example embodiment.

FIG. 12 is a flowchart illustrating processing relating to a PAIR rule in the example embodiment.

### DETAILED DESCRIPTION

The example embodiments described below can provide a method and system for incorporating more-than-one neural-network-based or machine-learning-based algorithms to function in a collective manner, to correlate collected data and improve the accuracy of attack detection. The system is manifested and named a Pattern Discovery Engine (PDE).

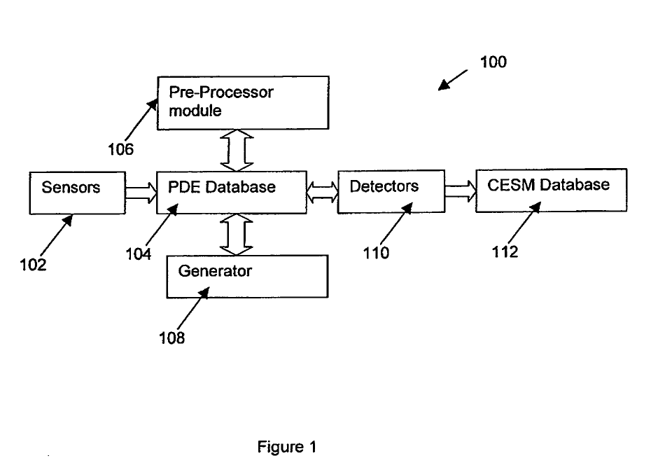

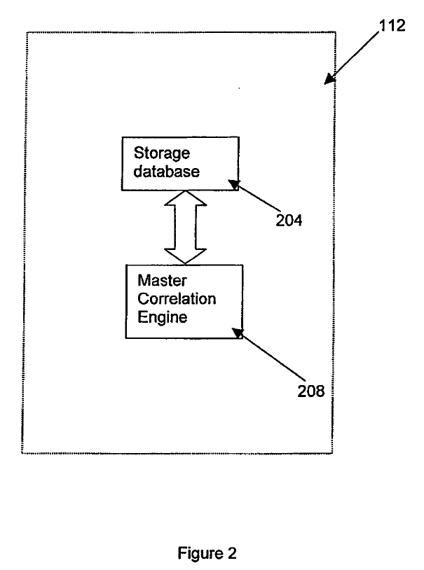

In an example embodiment, the Pattern Discovery Engine (PDE) 100 framework is formed. The PDE 100 framework comprises, with reference to FIG. 1, sensors e.g. 102, a PDE database e.g. 104, a pre-processor module e.g. 106, a generator e.g. 108, detectors e.g. 110 and an Enterprise Security Management database (CESM database) e.g. 112. In the example embodiment, with reference to FIG. 2, the CESM database e.g. 112 comprises a storage database e.g. 204, and a Master Correlation Engine e.g. 208.

In the same example embodiment, referring to FIG. 1, the generator e.g. 108 generates rules based on a variety of unsupervised machine-learning algorithms and the generated rules are stored in the PDE database e.g. 104. The data in the PDE database e.g. 104 comprises real-time network traffic connection records. The detectors e.g. 110 compares the network traffic connection records in the PDE database e.g. 104 for abnormal data based on the rules also stored in the PDE database e.g. 104. Each anomaly detected is translated into a transportable incident format (TIF) by the detectors e.g. 110 and stored in the CESM database e.g. 112, in the example embodiment. In the CESM database e.g. 112, machine-learning algorithms can be utilised to generate further rules to detect abnormal behaviour in the TIF stored in the storage database e.g. 204 (FIG. 2). The Master Correlation Engine e.g. 208 may be applied to the TIF to perform further actions such as event aggregation, event suppression and event correlation based on correlation rules stored in the Master Correlation Engine e.g. 208 (FIG. 2).

Human intervention is minimal and restricted to providing initial parameters for the machine-learning algorithms in the generator e.g. 108 and the Master Correlation Engine e.g. 208 (FIG. 2). Rules that are generated by the generator e.g. 108 and the Master Correlation Engine e.g. 208 (FIG. 2) are “fluid” and may be re-generated based on new and different sets of data received by the sensors e.g. 102 and stored in the PDE database e.g. 104 or TIF stored in the CESM database e.g. 112. In the example embodiment, the Master Correlation Engine e.g. 208 provides an element of decision making to the anomaly detected by the PDE 100 (FIG. 1). In the example embodiment, event aggregation by the Master Correlation Engine e.g. 208 reduces the number of attack events if they originate from a series of attacks. Event suppression provided by the Master Correlation Engine e.g. 208 suppresses non-critical events such as false positives so that only critical security alerts are presented to security administrators. Using event correlation, the Master Correlation Engine e.g. 208 can detect composite events, for example a composite event such as a network host becoming a source of subsequent attack events after the network host is subjected to an attack such as a worm.

With reference to FIG. 1, the sensors e.g. 102 are typically network traffic sniffing services installed in a network to gather network data and to create network traffic connection records that are stored in the PDE database e.g. 104. The pre-processor module e.g. 106 derives network information through calculations based on the network traffic connection records created by the sensors e.g. 102 within a specific sliding time-window. The generator e.g. 108 applies the selected machine-learning algorithms on the network traffic connection records that are stored in the PDE database e.g. 104 so as to generate different sets of rules for anomaly detection. The set of rules for detecting anomalies are stored in the PDE database e.g. 104. In the example embodiment, the detectors e.g. 110 carry out anomaly detection on the network traffic connection records that are stored in the PDE database e.g. 104 by utilising the set of rules generated by the generator e.g. 108 and stored in the PDE database e.g. 104. The detectors e.g. 110 translate each detected anomaly into a TIF. The TIF are then stored in the CESM database e.g. 112. In the example embodiment, the selected machine-learning algorithms may be further applied on the TIF that are stored in the storage database e.g. 204 (FIG. 2) to generate a set of further rules for anomaly detection. The set of further rules may be utilised to detect anomalies in the TIF, either before or after processing by the Master Correlation Engine e.g. 208. In the example embodiment, the Master Correlation Engine e.g. 208 executes actions comprising event aggregation, event suppression and event correlation, based on a set of specified correlation rules applied to the TIF.

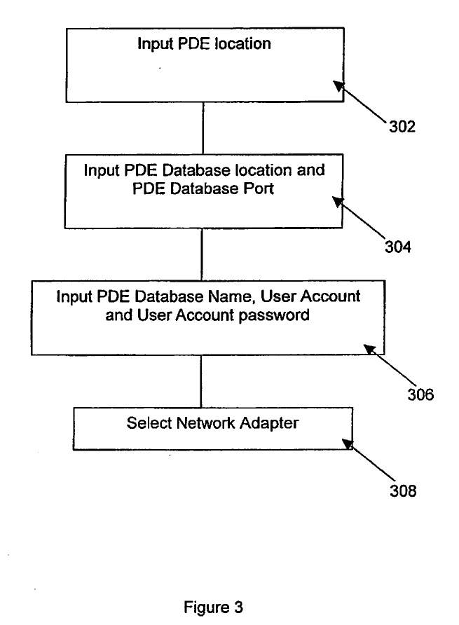

In the example embodiment, in order to configure the sensors e.g. 102, with reference to FIG. 3, the following steps are taken. At step 302, an Internet protocol (IP) address of the PDE is inputted for specifying the PDE location. At step 304, an IP address of the PDE database e.g. 104 (FIG. 1) and a listening port of the PDE database e.g. 104 (FIG. 1) are inputted. At step 306, in order to connect the PDE database e.g. 104 (FIG. 1), the name of the PDE database e.g. 104 (FIG. 1), a database user account and the user account password are inputted. At step 308, a network adapter is selected to enable the sensors e.g. 102 (FIG. 1) to carry out packet sniffing.

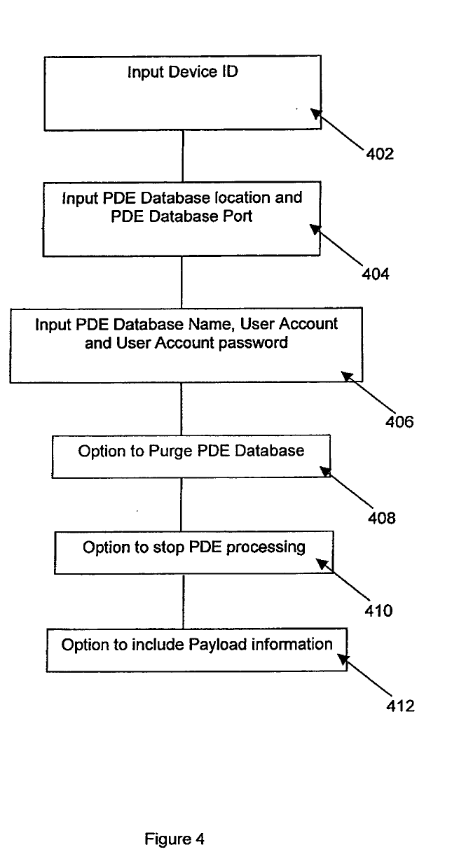

In the example embodiment, to configure the PDE 100 (FIG. 1), the following steps are taken. With reference to FIG. 4, at step 402, a device ID is specified to store TIF in the CESM database e.g. 112 (FIG. 1). At step 404, the IP address of the PDE database e.g. 104 (FIG. 1) and the listening port of the PDE database e.g. 104 (FIG. 1) are inputted. At step 406, the name of the PDE database e.g. 104 (FIG. 1), the database user account and the user account password are inputted. At step 408, an option to purge the PDE database e.g. 104 (FIG. 1) may be selected and if the option is selected, a frequency to purge the PDE database e.g. 104 (FIG. 1) can be inputted to execute the purging. At step 410, an option can be selected to stop the PDE 100 (FIG. 1) from carrying out any processing. At step 412, an option can be selected to include the payload information of each network traffic connection record associated with each TIF in the PDE database e.g. 104 (FIG. 1).

In the example embodiment, at step 404, if the specified PDE database e.g. 104 (FIG. 1) cannot be located on the network server through the specified IP address, the PDE 100 (FIG. 1) creates a new database for the PDE 100.

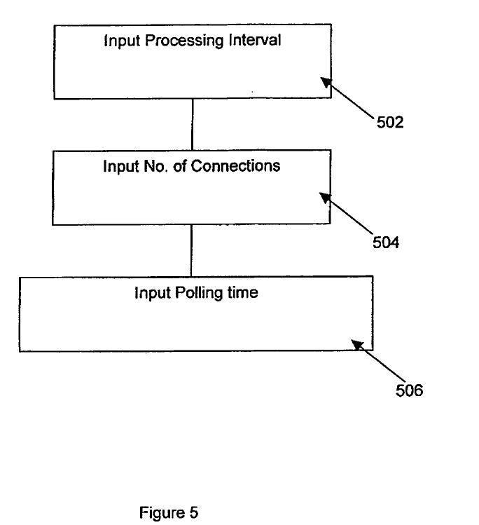

In the example embodiment, with reference to FIG. 5, to configure the pre-processor module e.g. 106 (FIG. 1), the following steps are taken. At step 502, a processing time is inputted for specifying the frequency for the pre-processor module e.g. 106 (FIG. 1) to process the network traffic connection records created by the sensors e.g. 102 (FIG. 1) and stored in the PDE database e.g. 104 (FIG. 1). At step 504, the number of network traffic connection records to be processed in order to capture network traffic connection records with similar characteristics is inputted and, at step 506, a polling time T is inputted for network traffic connection records with similar characteristics to be captured in the last T period. In the example embodiment, if the option to purge the PDE database e.g. 104 (FIG. 1) was selected at step 408 (FIG. 4), the pre-processor module e.g. 106 (FIG. 1) purges the PDE database e.g. 104 (FIG. 1).

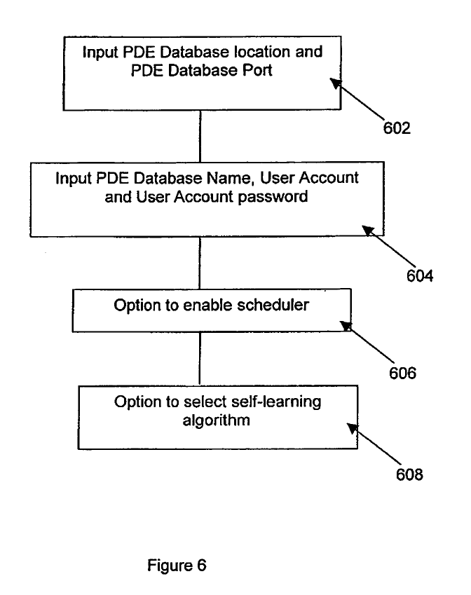

In the example embodiment, with reference to FIG. 6, to configure the generator e.g. 108 (FIG. 1), the following steps are taken. At step 602, the IP address of the PDE database e.g. 104 (FIG. 1) and the listening port of the PDE database e.g. 104 (FIG. 1) are inputted. The PDE database e.g. 104 (FIG. 1) stores the rules created by the generator e.g. 108 (FIG. 1). At step 604, the name of the PDE database e.g. 104 (FIG. 1), the database user account and the user account password are inputted. At step 606, an option may be selected to enable operating the generator e.g. 108 (FIG. 1) based on a scheduler. At step 608, a machine-learning algorithm may be selected for the generator e.g. 108 (FIG. 1) to generate rules.

At step 606, if the option is selected, a start time and duration time is inputted into the configuration of the generator e.g. 108 (FIG. 1). The generator e.g. 108 (FIG. 1) begins a learning process at the inputted start time and continues the learning process for a period corresponding to the inputted duration time. After the duration time expires, the learning process is automatically stopped and the generator e.g. 108 (FIG. 1) then automatically generates rules.

At step 608, in the example embodiment, four predefined methods pattern discovery methods for selection of machine-learning algorithms are provided. Additional machine-learning algorithms can be developed using added pattern discovery methods into the PDE 100 using a pre-defined set of application programmable interface (API). The four pattern discovery methods with default algorithm parameters and their configuration options are described below.

### Pattern Discovery Method 1

The first pattern discovery method utilises a Support Vector Machines (SVM) algorithm. SVM comprises learning machines that plot training vectors in a high-dimensional feature space and labels each training vector by class. The SVM classifies data by determining a set of support vectors. The support vectors are members of the set of training vectors that outline a hyper plane in the high-dimensional feature space. The SVM provides a generic mechanism that fits the surface of the hyper plane to the data by using a kernel function. A user of Pattern Discovery Method 1 may provide a function to the SVM during the learning process and the SVM may select support vectors along the surface of the function. The function may comprise a linear, a polynomial or a sigmoid function.

In the example embodiment, to configure the Pattern Discovery Method 1, parameters for the SVM algorithm may be inputted into the generator e.g. 108 (FIG. 1). Table 1 below lists the algorithm parameters and description of the parameters.

TABLE 1
Algorithm parameters for Pattern Discovery Method 1

| Algorithm | |
|---|---|
| Parameter | Description |
| Kernel | Four basic kernel types for selection: linear, polynomial, |
| Type | radial basis function and sigmoid |
| Gamma | Gamma value to be used in the selected kernel type of |
| | polynomial, radial basis function and sigmoid |
| NU | This parameter controls the trade-off between distance of the |
| | hyper-plane from the origin and the number of points in |
| | training dataset |
| Degree | This sets the degree parameter in the polynomial kernel type |
| Coef0 | This sets the Coef0 parameter in the kernel type |
| Epsilon | This sets the tolerance of termination criterion |

### Pattern Discovery Method 2

The second pattern discovery method utilises a Self Organising Feature Maps (SOM) algorithm. The SOM algorithm is an artificial neural network algorithm based on unsupervised learning. The SOM constructs a preserving topology mapping from a high-dimensional space onto map units so that relative distances between data points are preserved. The map units or neurons form a two-dimensional regular lattice where the location of a map unit carries the semantic information of the lattice carrying information about clustering. Semantic information that are clustered and mapped from the higher dimension space into 2-dimension space lattices will carry information about the higher-dimension space.

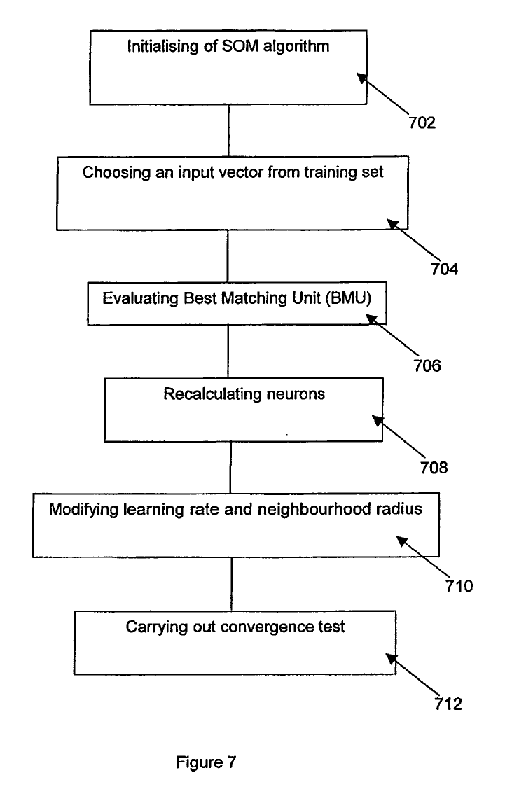

With reference to FIG. 7, at step 702, initialisation of the SOM algorithm is carried out. Initialisation of the SOM algorithm comprises setting all-dimensional neurons either arbitrarily or using first principal components. Initialisation of the SOM algorithm further comprises initialising a learning rate and a neighbourhood radius of the SOM algorithm. At step 704, an input vector is chosen from a training set and, at step 706, a Best Matching Unit (BMU) is evaluated to locate a neuron closest to the BMU. At step 708, the neuron closest to the BMU and its neighbouring neurons are recalculated, at step 710, the initial learning rate and neighbourhood radius are modified and, at step 712, a convergence test is carried out.

In the example embodiment, to configure the Pattern Discovery Method 2, parameters for the SOM algorithm may be inputted into the generator e.g. 108 (FIG. 1). Table 2 below lists the algorithm parameters and description of the parameters.

TABLE 2
Algorithm parameters for Pattern Discovery Method 2

| Algorithm | |
|---|---|
| Parameters | Description |
| Learning | During initialisation for learning in the SOM algorithm, a |
| Rate | large learning rate is utilised. Subsequent fine-tuning uses |
| | a lower learning rate. The learning rate should preferably |
| | be low for the SOM algorithm. |
| Grid | The grid number is in relation to a two-dimensional regular |
| Number | lattice. E.g. if the value of Grid Number is 10, the |
| | dimension of the lattice is 10 × 10. |

### Pattern Discovery Method 3

The third pattern discovery method utilises a k-nearest neighbour (KNN) algorithm. The third pattern discovery method is a geometric framework for unsupervised anomaly detection. The KNN algorithm is an algorithm that stores all available examples and classifies new data based on a similarity measure of the available examples. The KNN algorithm may be varied to address function approximation. In the example embodiment, the KNN algorithm detects anomalies based on computing the k-nearest neighbours of each point. If the sum of the distances to the k-nearest neighbours from a point is greater than a desired threshold, the KNN algorithm considers the point as an anomaly.

In the example embodiment, to configure the Pattern Discovery Method 3, parameters for the KNN algorithm may be inputted into the generator e.g. 108 (FIG. 1). Table 3 below lists the algorithm parameters and description of the parameters.

TABLE 3
Algorithm parameters for Pattern Discovery Method 3

| Algorithm | |
|---|---|
| Parameters | Description |
| Value of K | Number of closest examples |
| Percentage | The percentage of clusters indicated here and containing the |
| of clusters | largest number of instances associated with the clusters are |
| | labelled as “normal”. The remaining clusters are labelled as |
| | “anomalous” |

In the example embodiment, in the KNN algorithm, each example is described by numerical attribute-values. The examples are stored in the learning phase. The distance between two example vectors is regarded as a measure of similarity between the two example vectors. In order to classify a new instance based on the example set, K examples, which are most similar to the new instance, are determined. The new instance is then classified according to the class that the majority of the K examples belong to.

### Pattern Discovery Method 4

The fourth pattern discovery method utilises a Clustering for Anomaly Detection (CLAD) algorithm. The CLAD algorithm gathers similar data instances into clusters and utilises distance metrics on the clusters to determine abnormal data instances. Clustering may be carried out on unlabelled data and may require only feature vectors without labels to be presented to the algorithm. In the example embodiment, each data point is represented as a feature vector by transforming the input data points. An assumption when using the CLAD algorithm is data instances having a same classification (e.g. “attack” or “normal”) are close to each other in a feature space under a suitable metric and data instances with different classifications are far apart. It is also assumed that the number of data instances representing normal network activity in the training set is significantly more than the number of abnormal or intrusion data instances.

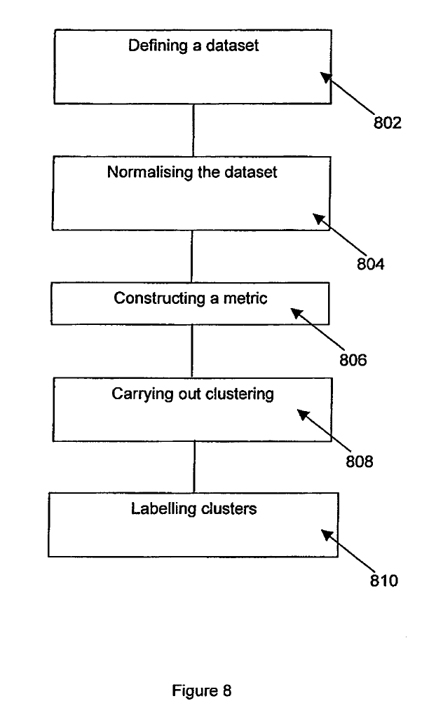

With reference to FIG. 8, at step 802, a dataset is defined, at step 804, normalisation is carried out on the dataset and, at step 806, and a metric is constructed. At step 808, clustering is carried out; at step 810 and the clusters are labelled.

At step 808, the CLAD algorithm begins with an empty set of clusters and the empty set of clusters is updated as the algorithm proceeds. For each new data instance retrieved from the normalised dataset, the algorithm computes a distance between the new data instance and each of the centroids of the clusters in the set of clusters. A cluster with the shortest distance between the new data instance and the centroid of the cluster is identified. If the distance is less than a constant W, the new data instance is assigned to the cluster.

At step 810, the CLAD algorithm labels an N percentage of the set of clusters containing the largest number of data instances associated with the clusters as “normal” while the remaining percentage of the set of clusters is labelled “anomalous”. Labelling of clusters provides determination of clusters containing anomalies as the CLAD algorithm deals with unlabelled data in the example embodiment.

In the example embodiment, to configure the Pattern Discovery Method 4, parameters for the CLAD algorithm may be inputted into the generator e.g. 108 (FIG. 1). Table 4 below lists the algorithm parameters and description of the parameters.

TABLE 4
Algorithm parameters for Pattern Discovery Method 4

| Algorithm | |
|---|---|
| Parameters | Description |
| Get Width | This parameter is the constant W used in the process of |
| Percentage | Clustering (i.e. At step 808 of FIG. 8) |
| Threshold | This parameter is the percentage of clusters containing the |
| Percentage | largest number of data instances. The clusters defined by |
| | this parameter will be labelled as “normal”. (i.e. At step |
| | 810 of FIG. 8) |

Collectiveness

In the example embodiment, as described above, network traffic connection records are collected from network traffic by the sensors e.g. 102 (FIG. 1). Without loss of generality, the network traffic connection records are split into data elements x₁ . . . , xₗ. In the example embodiment, the space of all possible data elements is defined as an input (instance) space X. The type of input space is dependent on the type of data being analysed by the PDE 100 (FIG. 1). In the PDE 100 (FIG. 1), the input space X can be the space of all possible network traffic connection records. Elements of the input space X are mapped out to points in a feature space Y. The feature space Y is a real vector space of some high dimension d, or more generally a Hilbert space. For analysis, the PDE 100 (FIG. 1) in the feature space Y defines a dot product between elements of the feature space Y.

PDE 100 (FIG. 1) algorithms may run in either parallel or serialized processes when processing feature space attributes. The order of parallel or serialized working pattern discovery algorithms may depend on the order of precedence of the algorithms. For example, in a serialized process, pattern discovery method ONE (PDM 1) has priority over pattern discovery method TWO (PDM 2) and so forth.

The outputs of the multiple different pattern discovery algorithms are structured based on a common uniform time-window and connection-window based feature space (the features are listed in Table 5). Structuring is done so that the different outputs can be referenced and worked upon by the PDE 100 (FIG. 1) in either a same parallel or a same serialized process. The PDE 100 (FIG. 1) can utilise information from the common feature space where required attributes have been mapped. Existing IDS which each utilise a single algorithm cannot be readily used with additional algorithms due to different result features or feature spaces. On the other hand, the PDE 100 (FIG. 1) in the example embodiment provides the ability to add additional pattern discovery methods through software API and allows further tuning and customisation of different algorithms to provide result features that can be unified in a common feature space.

The choice of network feature relates to the accuracy of anomaly detection in the PDE 100 (FIG. 1). Basic features may include source IP address and service port, destination IP address and service port, protocol, flags, number of bytes and number of packets. Derived features may include time-window based features and connection-window based features. In the example embodiment, time-window based features are constructed to capture connections with similar characteristics in the last T seconds, since Denial of Service (DoS) attacks and scanning attacks typically involve hundreds of connections.

On the other hand, slow scanning activities are typically attacks that scan the hosts (or ports) and use a much larger time interval than a few seconds. For example, a one-scan-per-minute or even one-scan-per-hour cannot be detected using derived time-window based features. In the example embodiment, in order to capture slow scanning activities, connection-window based features are derived so as to capture the same characteristics of the connection records as time-window based features, but are computed in the last N connections. Table 5 below lists both the time-window and connection-window based features in the example embodiment.

TABLE 5
Time-window and connection-window based features

| | |
|---|---|
| Feature Name | Feature description where T = 5, N = 100 |

Basic Features

| | |
|---|---|
| sourceip | Source IP |
| sourceport | Source Port |
| destinationip | Destination IP |
| destinationport | Destination Port |
| protocol | Protocol |
| flags | Flags |
| numberofbytes | Number Of Bytes |
| numberofpackets | Number Of Packets |

Time-Window based Features

| | |
|---|---|
| count_src | Number of connections made by same source as current record in last |
| | T seconds |
| count_dest | Number of connections made to same destination as current record in |
| | last T seconds |
| count_serv_src | Number of different services from same source as current record in |
| | last T seconds |
| count_serv_dest | Number of different services to same destination as current record in |
| | last T seconds |

Connection-window based Features

| | |
|---|---|
| count_src1 | Number of connections made by same source as current record in last |
| | N connections |
| count_dest1 | Number of connections made to same destination as current record in |
| | last N connections |
| count_serv_src1 | Number of connections with same service made by same source as |
| | current record in last N connections |
| count_serv_dst1 | Number of connections with same service made to same destination |
| | as current record in last N connections |

There are two types of attributes in each network traffic connection record. The two types of attributes are namely, numerical attributes and discrete attributes. Numerical attributes in network traffic connection records may include the number of bytes in a connection or the number of connections to a same port. Discrete attributes in network traffic connection records may include the type of protocol utilised for the connection or the destination port of a connection. Discrete and numerical attributes are handled differently in the PDE 100 (FIG. 1). All attributes are then normalised to the number of standard deviations away from the mean. Normalising scales distances between two points based on the likelihood of the attributes values. In the example embodiment, the feature map is data dependent because the distance between two points depends on the mean and standard deviation of the attributes, which in turn depend on the distribution of attribute values over all of the data. The PDE 100 (FIG. 1) detects points that are furthest apart from most other points or in relatively sparse regions of the feature space. This may be described as being similar to a typical problem of outlier detection. In the example embodiment, the points are references in data that are gathered by the sensors e.g. 102.

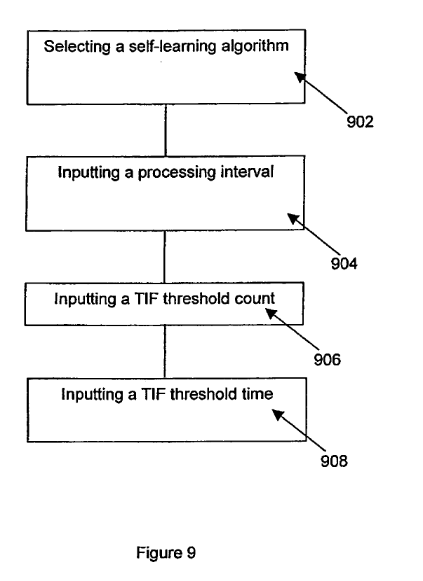

With reference to FIG. 9, to configure the detectors e.g. 110 (FIG. 1), the following steps are taken. At step 902, a machine-learning algorithm is selected and, at step 904, a processing interval is inputted to specify a processing frequency of the detectors e.g. 110 (FIG. 1). At step 906, a pattern or TIF threshold count is specified and, at step 908, a pattern or TIF threshold time is inputted to specify the time threshold for the detectors e.g. 110 (FIG. 1) to hold the TIF. In the example embodiment, the pattern or TIF threshold count specifies the count threshold for the detectors e.g. 110 (FIG. 1) to be triggered.

Using a graphic user interface named an Incident Editor provided in the PDE 100 (FIG. 1) allows a user of the PDE 100 (FIG. 1) to cleanse and perform assertion of the abnormal and normal classification of network traffic based on previous generated rules. The Incident Editor allows the user to select a pattern discovery method and displays the generated rules based on the selected pattern discovery method. The Incident Editor allows the user to purge the PDE database e.g. 104 (FIG. 1) and regenerate (re-learn) rules based on the selected pattern discovery method.

The generated rules are displayed as “Abnormal” and “Normal” rules in the Incident Editor. “Abnormal” rules may be used to identify anomalies in the network traffic while “normal” rules may be used to identify normal occurrences in the network traffic. Each generated rule is displayed with a Rule ID and the network traffic connection records associated with each generated rule are displayed with each Rule ID. The information including Payload or Packet Header of the network traffic recorded may be further analysed by the user utilising the same Incident Editor. When anomalous events are detected, they are translated into TIF by the detectors e.g. 110 (FIG. 1) and stored in the CESM database e.g. 112 where processes including event correlation can be carried out.

The four methods for detecting anomalies in the feature space described above can generate rules in the generator e.g. 108 and the rules may be utilised by the detectors e.g. 110 for detection of anomalies in unlabelled data. By utilising machine-learning algorithms, the PDE 100 is not “static” in nature, as it does not require constant updating and labelling of a set of training data for reference. Due to the self-learning nature of the PDE, the PDE 100 is “fluid” and significantly reduces the level of human intervention required as compared to typical signature-based IDS or typical anomaly-based IDS. In the example embodiment, using the PDE may reduce human errors that may arise in e.g. human input labelling of data sets in existing IDS.

In FIG. 2, in the example embodiment, machine-learning algorithms may be utilised to analyse the TIF data stored in the storage database e.g. 204 of the CESM database e.g. 112. Depending on the configuration of the CESM database e.g. 112, anomaly detection may be carried out on the TIF in the storage database e.g. 204 either before or after the TIF are processed by the Master Correlation Engine e.g. 208. In the example embodiment, TIF being stored in the storage database e.g. 204 of the CESM database e.g. 112 may be filtered off. The TIF may be filtered off as either “normal” network traffic or “abnormal” network traffic. In the example embodiment, a user may select to either “Drop abnormal TIF” or “Drop normal TIF”. Selecting “Drop abnormal TIF” configures the CESM database e.g. 112 to filter off TIF that are determined to be anomalies while selecting “Drop normal TIF” configures the CESM database e.g. 112 to filter off TIF that are determined to be normal.

Depending on the configuration of the CESM database e.g. 112, machine-learning algorithms may be applied to the TIF either “Pre-correlation” or “Post-correlation”. The machine-learning algorithms are applied to the TIF to generate further rules for detecting anomalies in the TIF. In the example embodiment, pre-correlation refers to applying the machine-learning algorithms to the TIF after the Master Correlation Engine 208 has processed the TIF. Post-correlation refers to applying the machine-learning algorithms to the TIF before the Master Correlation Engine 208 has processed the TIF.

Actions comprising event aggregation, event suppression and event correlation based on a set of specified correlation rules and relating to the TIF stored in the storage database e.g. 204 may be executed by the Master Correlation Engine e.g. 208 either before or after applying the machine-learning algorithms to the TIF stored in the storage database e.g. 204. In the example embodiment, a correlation may be formed when a TIF matches a pattern as specified in a correlation rule and a correlation may be formed by one or more TIF, depending on the applied correlation rule.

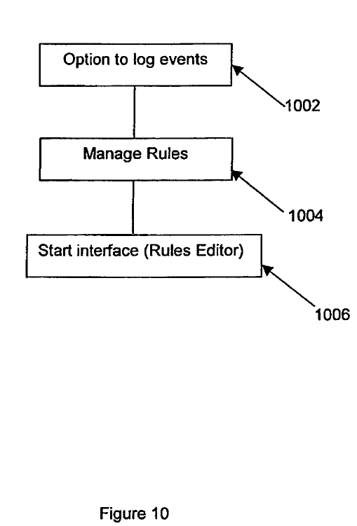

With reference to FIG. 10, to configure the Master Correlation Engine e.g. 208 (FIG. 2), the following steps are taken. At step 1002, an option to log events can be selected. At step 1004, an option to manage correlation rules may be selected to load a Rules Editor. At step 1006, an interface is provided as the Rules Editor so that correlation rules can be created, edited or deleted, using the interface.

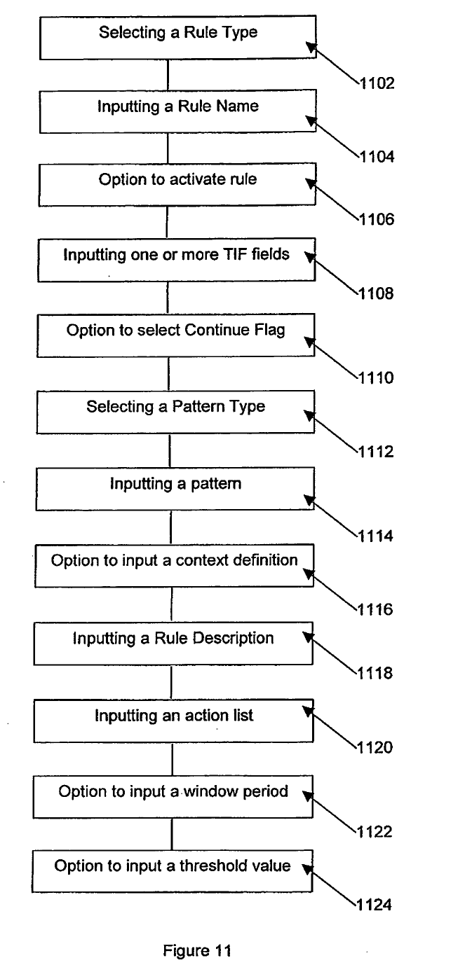

With reference to FIG. 11, in order to create a new correlation rule, the following steps are taken. At step 1102, a Rule Type is selected from a list of Rule Types. At step 1104, a Rule Name is inputted. At step 1106, an option to activate the correlation rule after creation of the correlation rule may be selected. At step 1108, one or more TIF fields to be used for comparison to a pattern in the correlation rule are inputted. At step 1110, an option (a Continue Flag) to send a TIF, after matching a rule pattern of the current correlation rule, to the next correlation rule may be selected. At step 1112, a pattern type is selected and at step 1114, a pattern belonging to the pattern type is inputted. At step 1116, an optional definition, of the context in which the correlation rule can be applied, may be inputted. At step 1118, a description of the correlation rule may be inputted as the Rule Description. At step 1120, one or more actions to be executed may be inputted when a matching TIF is detected. At step 1122, if applicable depending on the correlation rule type, a duration of a time window may be inputted. At step 1124, if applicable depending on the correlation rule type, a threshold value may be inputted.

At step 1102, an example of a correlation rule type is a PAIR rule type. In the example embodiment, a correlation rule belonging to the PAIR rule type involves two events. The correlation rule executes a first specified action at the first instance of a TIF that matches a first specified pattern of the correlation rule. Subsequent matching TIF are ignored by the correlation rule until a matching TIF matching the first pattern of the correlation rule match a second pattern of the correlation rule as well. A second specified action is then executed. This correlation rule type can be used as a temporal relationship event correlation operation where two or more events are reduced into an event pair within a specified window period. Table 6 below lists the parameters of a PAIR rule and description of the parameters.

TABLE 6
Parameters for a correlation rule, PAIR type

| Parameters | Description |
|---|---|
| Rule Details 1 - Continue | Specifies if TIF that match the first pattern of a |
| | correlation rule are passed to a next correlation rule |
| Rule Details 1 - Pattern | Regular expression or sub-string that TIF are |
| | compared to so as to detect matches of the first |
| | pattern of the correlation rule |
| Rule Details 1 - Context | (Optional) context definition |
| Rule Details 1 - Rule description | Rule description of the first pattern of the correlation |
| | rule |
| Rule Details 1 - Action | Action list that is executed when there is a match for |
| | the first pattern of the correlation rule. Subsequent |
| | matches are ignored. |
| Rule Details 2 - Continue | Specifies if TIF that match the second pattern of the |
| | correlation rule are passed to a next correlation rule |
| Rule Details 2 - Pattern | Regular expression or sub-string that TIF are |
| | compared to so as to detect matches of the second |
| | pattern of the correlation rule |
| Rule Details 2 - Context | (Optional) context definition. If the second pattern is a |
| | regular expression, the values of the second pattern |
| | of the correlation rule are used. Otherwise, values of |
| | the first pattern of the correlation rule are used. |
| Rule Details 2 - Rule description | Rule description of the second pattern of the |
| | correlation rule. If either the first pattern or second |
| | pattern of the correlation rule is a regular expression, |
| | special variables such as $0, $1 can be used as this |
| | parameter. If the second pattern of the correlation rule |
| | is a regular expression, the values of the second |
| | pattern of the correlation rule are used. Otherwise, |
| | values of the first pattern of the correlation rule are |
| | used. |
| | If both the first pattern and the second pattern of the |
| | correlation rule are regular expressions, special |
| | variables such as % 0, % 1 can be used to retrieve the |
| | values of the first pattern of the correlation rule and |
| | variables such as $0, $1 can be used to refer to the |
| | values of the second pattern of the correlation rule. |
| Rule Details 2 - Action | Action list that is executed when there is a match for |
| | the second pattern of the correlation rule. Subsequent |
| | matches are ignored. |
| | If either the first pattern or second pattern of the |
| | correlation rule is a regular expression, special |
| | variables such as $0, $1 can be used as this |
| | parameter. If the second pattern of the correlation rule |
| | is a regular expression, the values of the second |
| | pattern of the correlation rule are used. Otherwise, |
| | values of the first pattern of the correlation rule are |
| | used. |
| | If both the first pattern and the second pattern of the |
| | correlation rule are regular expressions, special |
| | variables such as % 0, % 1 can be used to retrieve the |
| | values of the first pattern of the correlation rule and |
| | variables such as $0, $1 can be used to refer to the |
| | values of the second pattern of the correlation rule. |
| Window | An optional time parameter that is allowed to elapse |
| | between the first detected matching instance of the |
| | first pattern of the correlation rule and the first |
| | detected instance of the second pattern of the |
| | correlation rule. If there are no detected instances of |
| | the second pattern of the correlation rule, the |
| | correlation operation terminates. |
| | A value of 0 or not setting this parameter equates to |
| | setting an infinite time. Thus, if there is no detected |
| | matching instances of the second pattern of the |
| | correlation rule, detected matching instances of the |
| | first pattern of the correlation rule are ignored. |

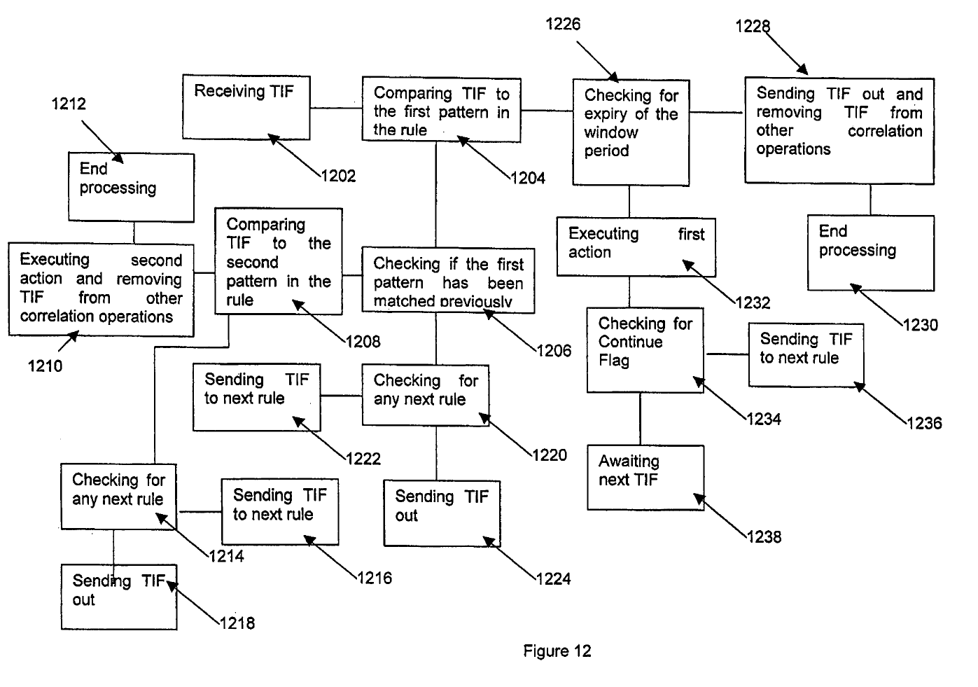

FIG. 12 is a flowchart illustrating processing relating to a PAIR rule in the example embodiment. At step 1202, a TIF is received by the Master Correlation Engine e.g. 208 (FIG. 2), and at step 1204, the specified TIF fields of the TIF are compared to the first specified pattern in the correlation rule to determine if there is matching. If the first specified pattern in the correlation rule is not matched at step 1204, at step 1206, a check is made to determine if the first specified pattern in the correlation rule was matched by previous TIF. If the first specified pattern in the correlation rule was matched by previous TIF at step 1206, at step 1208, the current TIF is compared to the second specified pattern in the correlation rule to determine if there is matching. If the second specified pattern in the correlation rule is matched at step 1208, at step 1210, the second specified action in the correlation rule is executed and the TIF is removed from other correlation operations, if there are any. At step 1212, the processing by the correlation rule is then ended. If the second specified pattern in the correlation rule is not matched at step 1208, at step 1214, a check is made to determine if there are any other correlation rules. If there are other correlation rules at step 1214, at step 1216, the TIF is sent to the next correlation rule. If there are no other correlation rules at step 1214, at step 1218, the TIF is sent out of the Master Correlation Engine e.g. 208 (FIG. 2).

If the first specified pattern in the correlation rule was not matched by previous TIF at step 1206, at step 1220, a check is made to determine if there are any other correlation rules. If there are other correlation rules at step 1220, at step 1222, the TIF is sent to the next correlation rule. If there are no other correlation rules at step 1222, at step 1224, the TIF is sent out of the Master Correlation Engine e.g. 208 (FIG. 2).

If the first specified pattern in the correlation rule is matched at step 1204, at step 1226, a check is made to determine if the window period has expired. If the window period has expired at step 1226, at step 1228, the TIF is sent out of the Master Correlation Engine e.g. 208 (FIG. 2) and the TIF is removed from other correlation operations, if there are any. At step 1230, the processing by the correlation rule is then ended. If the window period has not expired at step 1226, at step 1232, the first specified action in the correlation rule is executed and at step 1234, a check is made by the Master Correlation Engine e.g. 208 (FIG. 2) to determine if the Continue Flag has been selected at step 1110 (FIG. 11). If the Continue Flag has been selected in step 1234, at step 1236, the TIF is compared with the next correlation rule. If the Continue Flag has not been selected, at step 1238, the Master Correlation Engine e.g. 208 (FIG. 2) waits for the next TIF.

Returning to FIG. 11, at step 1108, TIF fields that may be used for comparison in the correlation rule are listed in Table 7 below.

TABLE 7
TIF Fields used for comparison

| TIF Fields | Description |
|---|---|
| atkdate | Attack Date |
| atktime | Attack Time |
| sourceIP | IP of source |
| targetip | IP of target |
| sourcename | Source name |
| targetname | Target name |
| sourceport | port of source |
| targetport | port of target |
| atktype | type of attack |
| deviceid | ID of device |
| severity | severity level of attack |
| occurrence | number of occurrences |
| remarks | remarks field |
| remarks2 | remarks field |

At step 1112, the pattern type may be selected from REGEXP or SUBSTR. REGEXP specifies the pattern type to be a regular expression while SUBSTR specifies the pattern type to be a substring that may be searched in the specified TIF fields as selected in step 1108.

At step 1116, the optional context definition is a logical expression and comprises context names for operands and logical expressions such as NOT, AND. In the example embodiment, if the logical expression in the context definition is true and if the specified pattern in the correlation rule is matched to a TIF, the TIF is considered to be matching and the action specified in the correlation rule is executed.

At steps 1116 to 1120, if the pattern specified in the correlation rule is a regular expression type with bracketing constructs, special variables such as $1 or $2 may be used in the e.g. context names, rule description or action parameters to get back-reference values. A special variable $0 may also be used to retrieve TIF that had matched the specified pattern in the correlation rule.

At step 1120, one or more actions to be executed may be inputted when a matching TIF is detected. Table 8 below lists examples of actions, which are supported by the Master Correlation Engine e.g. 208 (FIG. 2).

TABLE 8
Actions that may be executed by correlation rules

| Action | Description |
|---|---|
| none | No action to be taken |
| send | Combines all matching TIF into a single TIF and sends the TIF to the next module |
| discard | Discards the TIF |
| create | syntax is “create [<context name> [<time> [<action list>]]]” |
| | i) Action creates a context with the name <context name> and a |
| | lifetime of <time> seconds. |
| | ii) % variables can be used <context name>. If <context name> is |
| | omitted, the default value is % s (or Rule Description). |
| | iii) A default value of 0 is assumed for <time>, which signifies an |
| | infinite lifetime for the context. |
| | iv) If <action list> is specified, the action list will be executed once the |
| | lifetime of the context expires. If <action list> comprises more than one |
| | action, the action list is enclosed in parentheses. |
| | v) In the event where the context already exists and the create action |
| | is used, the lifetime of the context is extended by <time> seconds. |
| delete | syntax is “delete [<context name>]” |
| | i) Action deletes the context with the name <context name>. |
| | ii) % variables can be used <context name>. If <context name> is |
| | omitted, the default value is % s (or Rule Description). |
| | iii) If a non-existent context is to be deleted, no operation is performed. |
| set | syntax is “set <context name> <time> [<action list>]” |
| | i) Action sets the context name to <context name> and resets the |
| | lifetime of the context to <time> seconds. |
| | ii) % variables can be used <context name>. |
| | iii) A default value of 0 is assumed for <time>, which signifies an |
| | infinite lifetime for the context. |
| | iv) If <action list> is specified, the action list will be executed once the |
| | lifetime of the context expires. If <action list> comprises more than one |
| | action, the action list is enclosed in parentheses. |
| event | syntax is “event [<time>] $0” |
| | i) Action creates the matching TIF in an event buffer after <time>. The |
| | Master Correlation Engine will process the TIF in the event buffer |
| | again before processing is done on other TIF. |
| | ii) Specifying 0 for <time> or omitting a value creates the TIF in the |
| | event buffer immediately. |
| | For example, event 300 $0 creates and stores the matching TIF in the |
| | event buffer after 300 seconds. |
| reset | syntax is “reset <rule name> [<rule description>]” |
| | i) Action cancels the event correlation operations of correlation rules |
| | with <rule name> and <rule description>. |
| | ii) % variables can be used <rule description>. If <rule description> is |
| | omitted, the default value is % s (or Rule Description). |

In the example embodiment, after creation of the correlation rules in the Master Correlation Engine e.g. 208 (FIG. 2), the correlation rules may be applied to TIF stored in the storage database e.g. 204 (FIG. 2) in order to perform actions comprising event aggregation, event suppression and event correlation.

In this example embodiment, correlation rules may be created to identify intruders and targeted servers by first identifying the intruders-servers relationships in security events and then grouping the intruders-servers based on one-to-one, one-to-many or many-to-one relationships.

With regards to the CESM database 112 (FIG. 2), the pattern discovery methods can generate further rules for detecting anomalies in the TIF stored in the storage database e.g. 204 (FIG. 2), either before or after processing by the Master Correlation Engine e.g. 208 (FIG. 2). In the example embodiment, the Master Correlation Engine e.g. 208 (FIG. 2) utilising specified correlation rules as described above allows the PDE 100 (FIG. 1) to execute actions comprising event aggregation, event suppression and event correlation. In the example embodiment, the Master Correlation Engine e.g. 208 (FIG. 2) provides an element of decision making for the PDE 100 (FIG. 1) as the actions are executed based on detected TIF stored in the storage database e.g. 204 (FIG. 2). Further, in the example embodiment, the Master Correlation Engine e.g. 208 (FIG. 2) can automate filtering of non-critical events and false alerts. Event correlation may also be performed in real-time by the Master Correlation Engine e.g. 208 (FIG. 2) as the TIF can be processed as soon as they are stored in the storage database e.g. 204 (FIG. 2). This can provide added advantage of reducing the time for responding to and preventing impending security attacks.

In the example embodiment described above, the PDE incorporates different machine learning algorithms for detecting anomalies in a collective manner. The PDE may not require significant human intervention and is able to detect and discover patterns in data based on a set of unlabelled data and statistical approaches. Human intervention may only be required for tuning the PDE, in relation to setting parameters of the pattern discovery methods, and for fine-tuning of the PDE, for example when new machines or elements are added into the computer networks. Utilising different machine learning algorithms for detecting anomalies in TIF as well as utilising the Master Correlation Engine may further reduce human intervention, further improve accuracy of anomaly detection and also incur relatively lower cost, when operating the PDE. In addition, utilising the Master Correlation Engine provides a relatively more accurate and efficient process of identifying and detecting critical security threats.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. An anomaly detection system comprising:
one or more distributed sensors for gathering network or log data;
one or more generators for generating discovery rules based on a collective set of pattern discovery algorithms including one or more unsupervised machine learning algorithms;
one or more detectors for detecting abnormal patterns in the network or log data gathered by the sensors based on the discovery rules generated by the generator; and
one or more correlation engine for determining intrusion counter measures based on matching features of one or more detected abnormal patterns with correlation rules.

2. The anomaly detection system as claimed in claim 1, wherein the algorithms are tuned such that each algorithm outputs attributes of features in a common feature space.

3. The anomaly detection system as claimed in claim 1, wherein the algorithms comprise more than one supervised learning algorithms and un-supervised learning algorithms.

4. The anomaly detection system as claimed in any one of claim 1, wherein the detectors generate a Transportable Incident Format (TIF) based on each detected abnormal pattern.

5. The anomaly detection system as claimed in claim 4, wherein the correlation engine determines anomaly countermeasures based on matching features of one or more TIF with the correlation rules.

6. The anomaly detection system as claimed in claim 4, wherein the generator further generates further discovery rules based on a collective set of pattern discovery algorithms, the detectors detect events from the TIF generated based on the further discovery rules generated by the generator, and the correlation engine determines the intrusion counter measures further based on the detected events.

7. The anomaly detection system as claimed in claim 6, wherein the further discovery rules are applied prior to or after the correlation engine determines anomaly countermeasures based on matching features of one or more TIF with the correlation rules.

8. The anomaly detection system as claimed in any one of claim 1, wherein the pattern or TIF discovery algorithms comprise One-Class Support Vector Machine algorithm.

9. The anomaly detection system as claimed in any one of claim 1, wherein the pattern or TIF discovery algorithms comprise Self-Organizing Map algorithm.

10. The anomaly detection system as claimed in any one of claim 1, wherein the pattern discovery algorithms comprise a K-Nearest Neighbor algorithm.

11. The anomaly detection system as claimed in any one of claim 1, wherein the pattern discovery algorithms comprise a Linkage Based Clusters algorithm.

12. The anomaly detection system as claimed in any one of claim 1, further comprising an algorithm application programmable interface (API) to support new supervised and unsupervised algorithms to be included in detection capability.

13. The anomaly detection system as claimed in any one of claim 1, wherein the generators comprise a graphical user interface for creating a new correlation rule.

14. The anomaly detection system as claimed in claim 13, wherein creating the new correlation rule comprises selecting a rule type.

15. The anomaly detection system as claimed in claim 13, wherein creating the new correlation rule comprises selecting a pattern type.

16. The anomaly detection system as claimed in any one of claim 13, wherein creating the new correlation rule comprises inputting an action list.

17. The anomaly detection system as claimed in any one of claim 13, wherein creating the new correlation rule comprises selecting a window period, a threshold value, or both.

18. The anomaly detection system as claimed in any one of claim 1, wherein the anomaly detection system is capable of running the algorithms in a parallel or serialized manner.

19. An anomaly detection method comprising:
utilising one or more distributed sensors for gathering network or log data;
utilising one or more generators for generating discovery rules based on a collective set of pattern discovery algorithms including one or more unsupervised machine learning algorithms;
utilising one or more detectors for detecting abnormal patterns in the network or log data gathered by the sensors based on the discovery rules generated by the generator; and
utilising one or more correlation engine for determining intrusion counter measures based on matching features of one or more detected abnormal patterns with correlation rules.
